(19) United States
(12) Patent Application Publication
(10) Pub. No.: US 2014/0136748 A1
(43) Pub. Date: May 15, 2014

(54) SYSTEM AND METHOD FOR PERFORMANCE OPTIMIZATION IN USB OPERATIONS

(71) Applicants: Choon Gun Por, Georgetown (MY); Sern Hong Phan, Bayan Lepas, 07 (MY)

(72) Inventors: Choon Gun Por, Georgetown (MY); Sern Hong Phan, Bayan Lepas, 07 (MY)

(21) Appl. No.: 14/129,535

(22) PCT Filed: Oct. 3, 2012
(86) PCT No.: PCT/US2012/000474

§ 371 Date: Dec. 26, 2013

(30) Foreign Application Priority Data
Oct. 3, 2011 (MY) PI 2011004736

(51) Int. Cl. G06F 13/28

(52) U.S. Cl. CPC G06F 13/28
USPC 710/308

(57) ABSTRACT

An apparatus may include a processor and first logic operable on the processor to output a direct memory access (DMA) activity indicator to indicate a current state of activity of direct memory access data transfer operations. The apparatus may further include second logic operable on the processor to determine scheduled DMA activity to be performed; and third logic operable on the processor to output a pre-wake indicator to a controller before the scheduled DMA activity is to be performed, to satisfy both Quality of Service (QOS) and Power saving needs. Other embodiments are disclosed and claimed.

### BACKGROUND

The Universal Serial Bus (USB) standards have been implemented to standardize the connection of computing devices to computer peripherals, such as keyboards, pointing devices, digital cameras, printers, portable media players, disk drives and network adapters, both to communicate and to supply electric power. The USB standard includes support for the host controller interface (HCI), which is a register-level interface that enables a host controller for USB to communicate with a host controller driver in software. The driver software is typically provided with an operating system of a computing device, but may also be implemented by application-specific devices such as a microcontroller. Among the HCI technologies supported in USB standards are (OHCI), universal host controller interface (UHCI), enhanced host controller interface (EHCI), and extensible host controller interface (xHCI). The EHCI standard provides high speed USB functions and relies upon a companion controller, either OHCI or UHCI to handle full or low speed device functions.

EHCI supports periodic data transfers such as interrupt and isochronous USB transfers. When a USB device “initiates” an interrupt transfer, an interrupt request is queued by the USB device until the host polls the USB device asking for data. An isochronous transfer, on the other hand, may occur continuously and periodically, and may involve time sensitive information such as an audio or video stream. In either type of transfer, the functioning of a main processor (CPU) in an apparatus containing the host controller and CPU may be affected. For example in an EHCI-supported direct memory access (DMA) transfer a DMA controller allows devices direct access to main memory without requiring CPU interventions. The DMA feature is found nearly ubiquitously in modern computing devices and allows hardware subsystems within a computing device to access memory independently of the CPU. In the absence of DMA, a CPU using programmed input/output (I/O) is typically fully occupied for an entire duration of a read or write operation, and is thus unavailable to perform other work. Using DMA, the CPU can initiate a transfer, perform other operations while the transfer is in progress, and receive an interrupt from the DMA controller once the operation has been done. This is useful any time the CPU cannot keep up with the rate of data transfer, or where the CPU can perform useful work while waiting for a relatively slow I/O data transfer. Similarly, a processing element inside a multi-core processor can transfer data to and from its local memory without occupying its processor time and allowing computation and data transfer concurrency.

In current technology, depending on the state of EHCI DMA activity, the CPU may enter a power saving C-state (where C0 refers to a normal operating power state, and states C1-C6 refer to lower power operating states, where C6 is a lowest power state, or “deepest” C-state). For example, a computing system may be arranged so that when a controller receives a signal that asserts (outputs) an EHCI DMA active state, the CPU is maintained at the lowest possible latency corresponding to a shallow C-state, such as C2. In this manner, some processor power may be conserved while the CPU may resume normal power operation with minimal delay.

On the other hand, if the controller receives a signal that de-asserts the EHCI DMA active state, it may be possible to place the CPU in a deeper C-state corresponding to less power consumption that the shallow C-state. In this manner, the overall system power consumption may be reduced. When the controller receives a signal that periodic EHCI traffic has resumed, the controller may send a wakeup signal to the CPU so that the CPU may resume normal operation in a higher power C-state. However, because of the latency associated with resuming normal operation for the CPU, processing of new traffic may be delayed when the CPU exits a deeper C-state.

Accordingly, there may be a need for improved techniques and apparatus to solve these and other problems.

### BRIEF DESCRIPTION OF THE DRAWINGS

FIG. 1 depicts a system for managing power and latency in a processor.

FIG. 2 depicts a system that includes one embodiment of a power management module.

FIG. 3a depicts an embodiment of a power management module that includes a frame index counter.

FIG. 3b depicts an embodiment of a pre-wake logic module.

FIG. 4 illustrates an exemplary scoreboard that includes multiple cells arranged in a data structure.

FIG. 5 depicts another instance of a scoreboard having another set of entries.

FIG. 6 depicts a third instance of a scoreboard having a third set of entries.

FIG. 7 depicts one exemplary logic flow.

FIG. 8 depicts another exemplary logic flow.

FIG. 9 depicts a further exemplary logic flow.

FIG. 10 depicts another exemplary logic flow.

FIG. 11 depicts an embodiment of a computing system.

FIG. 12 illustrates one embodiment of a computing architecture.

### DETAILED DESCRIPTION

Embodiments may include improved apparatus and methods for scheduling CPU operation for handling USB data. As noted, USB data may be delivered in isochronous or interrupt data transfers in various embodiments. In order to facilitate handling of USB transfers, a USB host controller may be located in a chipset. The USB host controller may perform EHCI and UHCI or OHCI data transfers. In various embodiments, a power management module may be employed to alert a controller as to current and future USB data transfer activity, thereby facilitating the ability of the controller to adjust the C-state of a CPU. The controller may place the CPU in a deeper CPU state and may bring the CPU into a shallower state in response to signals received from the power management module.

A processor such as a CPU is generally regarded as being in a “C0” state if the processor is operating at a normal power level. The processor may enter a series of higher C-states in which progressively less power is consumed. In a C1 state, for example, some internal clocks may be gated and some internal clocks may be stopped in a C2 state. However, in either a C1 or C2 state, the processor may be restored to the C0 state with a minimal latency for exiting the existing state and returning to the C0 state. The “C3” state generally refers to a state in which power consumption is less than a C2 state. For example, in a C3 state, the processor cache may not be snooped. In a C4 state internal clocks may be stopped and internal CPU voltage may be reduced. In a C6 state, the internal CPU voltage may be reduced to as low as 0 V and the architectural state of the CPU may be stored in a static random access memory array (SRAM). The latency for restoring a CPU to a C0 state from a deeper C-state may be much larger for the deepest C-states. For example, latencies of 100 μs or more may occur for restoring CPU operation from a C6 state to a C0 state.

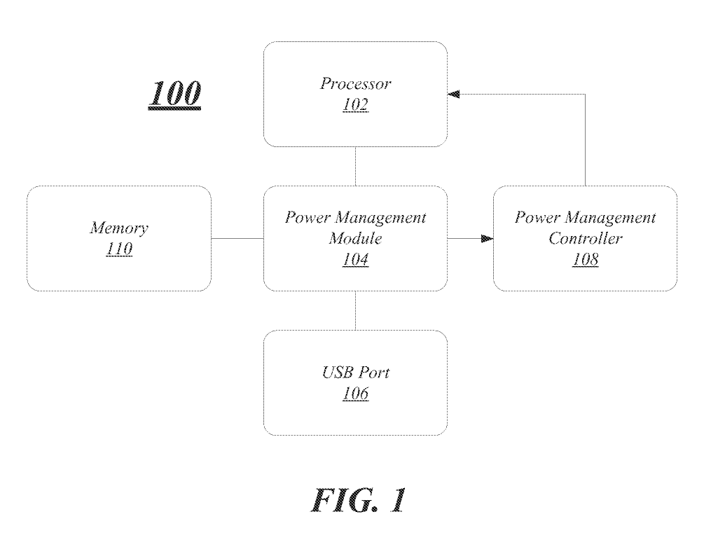

FIG. 1 depicts a system 100 for managing power and latency in a processor 102. In various embodiments processor 102 may be a CPU in a computing device that is coupled to one or more other devices through a USB port 106. System 100 includes a power management module 104 coupled to the processor 102, and also coupled to a power management controller 108. In various embodiments, as detailed below, power management module 104 may provide signals to power management controller 108, which trigger power management controller 108 to adjust the power state of processor 102. In some embodiments, the power management module may be located in a chipset, such as in an I/O controller hub (ICH), Southbridge, or other component of system 100 that may include or may be coupled to a USB host controller (not explicitly shown).

The operating system of system 100 may schedule a periodic USB list to communicate an isochronous data transfer or interrupt transfer. Such a list may be stored in a memory 110 of system 100. The list may instruct a USB host controller when to run interrupt and isochronous transfers to and from USB port 106. In various embodiments USB data may be transferred between an ICH and USB port according to standard USB frame units, which may be 1 ms frames in the case of UHCI/OHCI traffic or 125 μs microframes in the case of EHCI traffic. Thus, data may be transferred from USB host controller to USB port in frames of duration 1 ms or microframes of duration 125 μs. As detailed below, the power management module may check microframes in which the periodic USB list has activity scheduled.

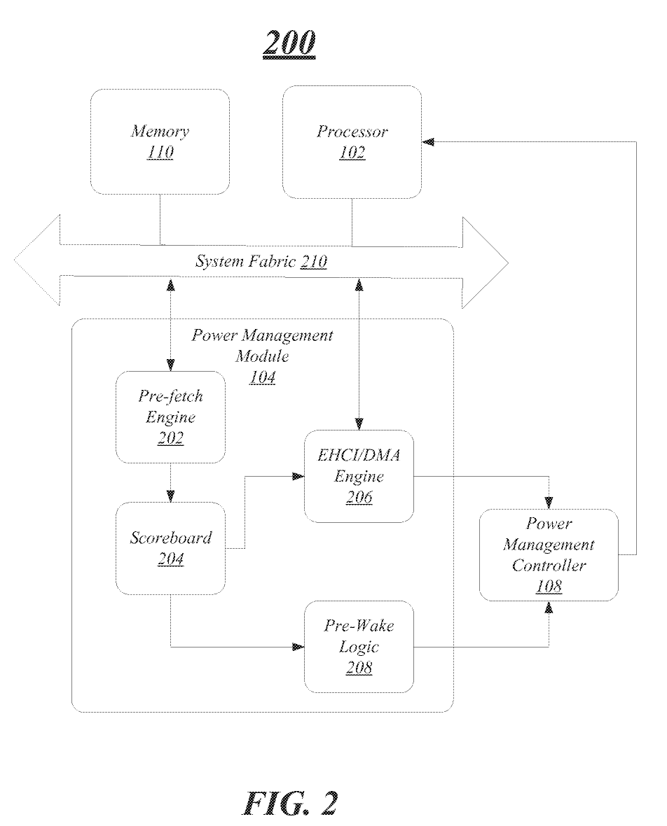

FIG. 2 depicts a system 200 that includes one embodiment of power management module 104. In this embodiment, the processor 102 is coupled to the power management module 104 through system fabric 210, which may include a memory bus in some embodiments. The power management module 104 includes a pre-fetch engine 202, which may be arranged to check USB frames where the periodic USB list has activity scheduled. Thus, during periods of USB inactivity, the cache of processor 102 need not be snooped, which facilitates the ability to place the processor 102 into a low power state, such as a C3-C6 state.

In various embodiments, the prefetch engine 202 may be arranged to prefetch a schedule of a USB DMA engine that accesses USB traffic such as EHCI, OHCI, or UHCI traffic. In particular embodiments as illustrated in FIG. 2, the USB DMA engine may be an EHCI DMA engine 206. In various embodiments, power management module 104 includes a scoreboard 204 that is coupled to prefetch engine 202. The structure of scoreboard 204 will be discussed further below. In some embodiments prefetch engine 202 may populate the scoreboard 204 with the prefetched EHCI DMA schedule. The EHCI DMA engine may also be coupled to memory 110 through system fabric 210. The scoreboard 204 may also be coupled to a pre-wake logic module 208. Each of EHCI DMA engine 206 and pre-wake logic module 208 may also be coupled to the power management controller 108. As detailed below, the scoreboard 204 may output entries which are used by EHCI DMA engine 206 and pre-wake logic module 208 to send messages to power management controller 108.

In various embodiments, the pre-fetch engine 202 may check for scheduled activity in USB frames in main memory, where the USB frames are being pointed to by a periodic list pointer. The pre-fetch engine 202 may then mark those frames having USB activity scheduled as “active” and frames not having USB activities scheduled as idle. The prefetch engine may store results in scoreboard 204, which may act as a future activity indicator. In the example illustrated in FIG. 2, the scoreboard may act as a future EHCI DMA activity indicator.

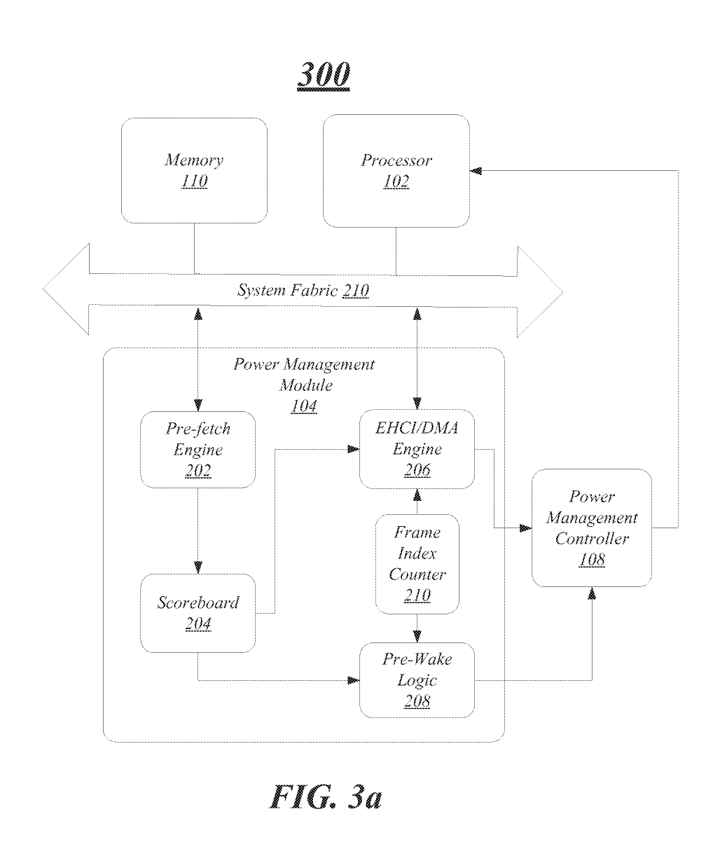

In various embodiments the power management module may monitor the current state of the EHCI DMA 206 engine using a counter. FIG. 3a depicts an embodiment in which the power management module includes a frame index counter 210 to track frames accessed by EHCI DMA engine 206, while FIG. 3b depicts an embodiment of a pre-wake logic module 302 explained further below.

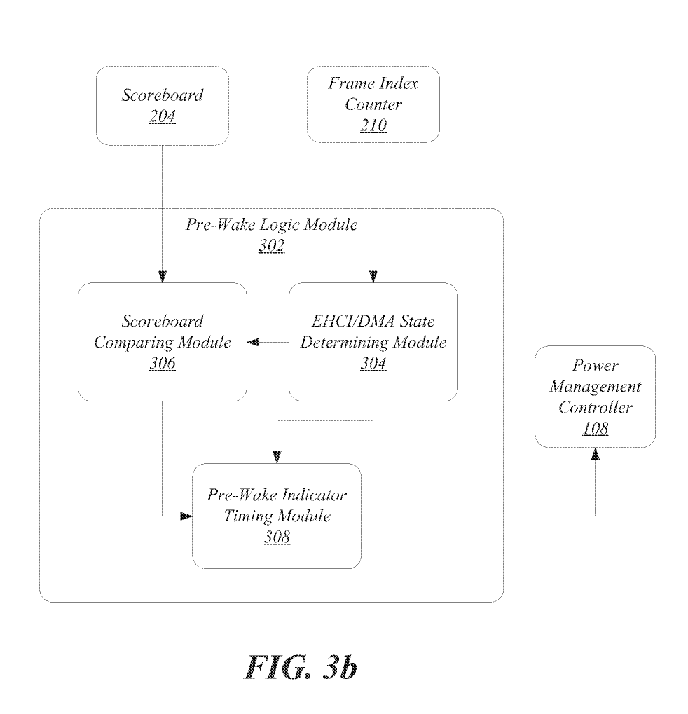

According to various embodiments, the scoreboard 204 may be arranged to maintain a per-micro frame indication of future EHCI DMA activity. FIG. 4 illustrates an exemplary scoreboard 204 that includes multiple cells 302 arranged in a data structure, where each cell 302 may correspond to a prefetched micro-frame. As illustrated, each cell 302 includes an entry that provides an indication of activity corresponding to that micro-frame. The scoreboard 204 is depicted at a first instance where multiple entries corresponding to EHCI DMA scheduled activity have been prefetched. In various embodiments, these entries are used by a logic unit, such as pre-wake logic module 208, to determine when to send a pre-wake indicator to power management controller 108, as detailed further below.

In accordance with various embodiments, the power management module 104 may direct the power management controller 108 to set the C-state of processor 102 using a combinations of signals sent from the pre-wake logic module 208 and EHCI DMA engine 206. When USB traffic such as interrupt or isochronous traffic is scheduled, the EHCI DMA engine 206 may access memory, such as memory 110. During this time, the EHCI DMA engine may assert a signal that is forwarded to power management controller 108. For example, EHCI DMA engine may be arranged to assert an “EHCI DMA active” indicator during periods of EHCI DMA traffic.

In some embodiments, this “EHCI DMA active” may be asserted after a period of inactivity when traffic is resumed. The signal may be sent to power management controller 108 so that power management controller 108 can adjust or maintain a C-state of processor 102. For example, if processor 102 is in a low power C2 state when the power management controller 108 receives a “EHCI DMA active” signal (or “indicator”), the power management controller may then recognize that the EHCI DMA engine is truly busy and that USB traffic is being processed. The power management controller 108 may therefore determine that the processor 102 should be maintained in the C2 state where a wakeup (or “exit”) latency from the C2 state is of a minimal duration. In this manner, the processor 102 may exit to a C0 power state with minimal delay to resume full power operation. In some embodiments, the power management module 104 may assert the “EHCI DMA active” indicator at the point when EHCI DMA traffic is resumed after a period of inactivity. Accordingly, the power management controller 106 may maintain the power state of processor 102 in a low latency C-state, such as C-2 or above (that is, C0) after receiving the “EHCI DMA active” indicator from EHCI DMA engine 206.

The power management module 104 may also be arranged to de-assert the “EHCI DMA active” signal, that is, to send an indicator of EHCI DMA inactivity to power management controller 108 during periods when no USB traffic is processed by EHCI DMA engine. When the “EHCI DMA active” signal is de-asserted by EHCI DMA engine 206, the power management controller 108 then may determine that processor 102 can be safely placed in a deeper C-state, such as a C6 state so that power can be saved.

In accordance with various embodiments, when it becomes necessary to wake up the processor 102 from the C6 state, the power management module may forward a timely signal to power management controller 108 to bring the processor 102 to the appropriate C-state, such as C0. In particular, a pre-wake indicator may be sent to power management controller 108 at a predetermined instance based upon scheduled USB traffic. For example, entries from scoreboard 204 may be forwarded to pre-wake logic 208. As noted above, these entries may comprise indicators of scheduled EHCI DMA activity. When pre-wake logic module 208 receives scoreboard entries from scoreboard 204, the pre-wake logic module 208 may then use the entries to determine when to schedule a pre-wake up indicator for sending to power management controller 108.

Because the pre-wake logic module 208 may receive the scoreboard entries well in advance of when EHCI DMA is to process the USB traffic denoted by the entries, the pre-wake logic module 208 may have sufficient time to provide a pre-wake indicator to power management controller 108 so that processor 102 can exit a deep C-state and wakes up to the appropriate C-state, such as C0, when EHCI DMA traffic resumes.

FIG. 3b depicts an embodiment of a pre-wake logic module 302. The pre-wake logic module 302 includes an EHCI DMA State Determining Module 304, which may determine a present state of operation of the EHCI DMA engine 206. For example, the present USB frame being accessed (also referred to herein as “current frame”) by EHCI DMA engine 206 may be determined by EHCI DMA State Determining Module 304 from an output of frame index counter 210. The pre-wake logic module 302 also includes a scoreboard comparing module 306, which may compare the current (micro)frame to the prefetched entries in scoreboard 204 to determine a time difference between a current USB (micro)frame being accessed by EHCI DMA engine 206 and a future USB (micro)frame that corresponds to a given pre-fetched entry in scoreboard 204. For example, the given prefetched entry in scoreboard 204 may be indicative of the resumption of EHCI DMA activity after an interval of inactivity. Accordingly, scoreboard comparing module 306 may map a given scoreboard cell to the corresponding future USB microframe to determine a difference in the future USB microframe and current USB microframe being accessed by EHCI DMA engine 206. This may thereby provide an indication of the lead time between the future activity denoted in the scoreboard 204 and the current activity.

The pre-wake logic module 302 may also include a pre-wake indicator timing module 308. The function of the pre-wake alert timing module 308 is to determine appropriate actions to take, if any, based upon the information from scoreboard comparing module 306 and EHCI DMA state determining module 304. For example, the pre-wake alert timing module 308 may determine timing for asserting a pre-wake alert indicator to power management controller 108. As detailed further below, the timing may be based upon the exit latency of the processor 102 from a current C-state.

One example of action that the pre-wake logic module 302 may take is to output the pre-wake indicator to the power management controller 108 for exiting the processor from the current C-state after determining the proper timing for outputting the pre-wake indicator. The time of asserting the pre-wake indicator may be calculated to optimize performance of the system 100. For example, the pre-wake logic module 208 may determine a future point in time at which a currently inactive EHCI DMA engine is to resume accessing memory 110. Based upon the determination of the time at which EHCI DMA activity is to resume, the pre-wake logic module may determine a second point in time that corresponds to when the processor 102 is to begin exit of the current C-state.

In particular, the determination of when to wake up a processor 102 from a deep C-state may involve periodic or intermittent review of a scoreboard as may be more fully understood by reference to FIGS. 4-6.

In the embodiment illustrated in FIG. 4, an entry of “1” may provide an indication of active state while a “0” provides an indication of an idle state. Each cell 402 in scoreboard 204 may be populated with an entry so that power management module 104 may interrogate any cell corresponding to a given micro-frame to determine EHCI DMA future activity. The embodiment illustrated in FIG. 4 is meant to depict an instance in time at which multiple entries for scheduled EHCI DMA have been prefetched and stored within the structure of scoreboard 204. The arrangement of the set of entries 400 may correspond to scheduled EHCI DMA activity in the following manner. The recently pre-fetched microframes may be populated into the first row, while the earliest pre-fetched microframes may occupy the last row F_{N}. The row F_{N} of prefetched activity indicators may therefore correspond to EHCI DMA operation(s) to be performed at the nearest point in time to the present. The higher rows may thus correspond to later instances in time, which were the most recently prefetched. In the example of FIG. 4, each row of N total rows may correspond to operations spaced at an interval of 1 ms from an adjacent row, that is, operations spaced apart by one USB frame. Accordingly, the “depth” of the scoreboard may correspond to N milliseconds. In addition, adjacent entries may correspond to operations spaced apart by a standard microframe period of 125 μs. In one example, the bottom region of the scoreboard may contain entries that correspond to current EHCI DMA activity. Thus, in the instance illustrated in FIG. 4, the pre-wake logic module 208 may determine that currently EHCI DMA engine 206 is accessing a microframe corresponds to entry F_{N} M₄ of scoreboard 204. As noted elsewhere this may be determined from a frame index counter 210 that tracks a current frame or microframe being processed by EHCI DMA engine 206. Thus, by inspecting entries 400 of scoreboard 204 the pre-wake logic module 208 determines that the EHCI DMA engine is currently inactive (entry of cell F_{N} M₄=0) and that no activity will resume until the instance corresponding to cell F₃ M₄, whose entry is “1.” In one example where N=4, the cell F₁ M₄ corresponds to a future time that is spaced from the present cell (F_{N} M₄) by 3 frames or 3 ms. Accordingly, pre-wake logic module 208 may determine that the processor 102 is to exit a current C-state (for example, C-6) at an instance that occurs before the EHCI DMA traffic resumption that is to occur 3 ms into the future. The pre-wake logic module 208 may further determine that the programmed exit latency for processor 102 from the C-6 state is about 100 μs. Based upon this exit latency, the pre-wake logic module 208 may determine that a pre-wakeup signal is to be initiated at an instance that is calculated to restore the processor to C-0 state in a manner that does not compromise the future EHCI DMA activity. For example, the pre-wakeup signal may be sent so that power management controller 108 initiates the exit of processor 102 from the C-6 state at an instance that is about 100 μs before the time corresponding to cell position F₃ M₄, or about 2.9 ms (=3−0.1 ms) from the present time.

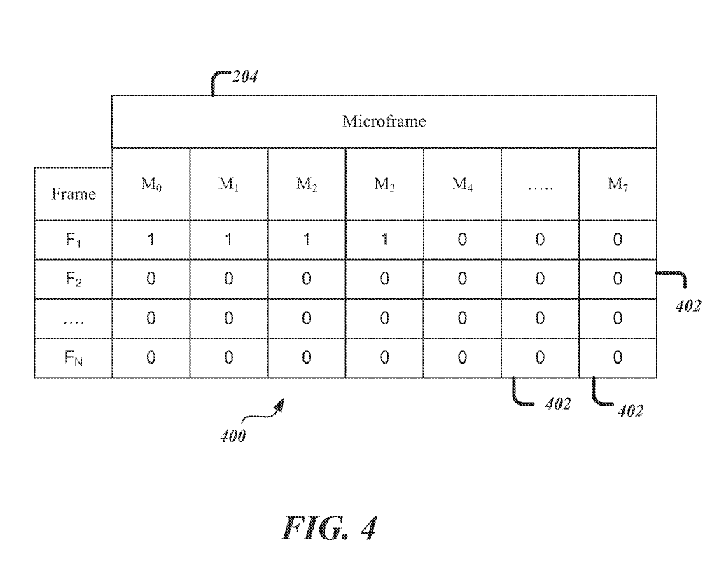

FIG. 5 depicts another instance of scoreboard 204 when another set of entries 500 are stored. In this instance, the scoreboard cells 402 have entries that all are “0,” or inactivity indicators. When the pre-wake logic module 208 examines scoreboard 204 at the instance depicted in FIG. 5, the pre-wake logic module 208 may determine that until a micro frame corresponding to cell position F₁M₀ a period of EHCI DMA inactivity will persist. At the time entries 500 are inspected, the frame counter index 210 may further indicate that the current frame being processed by EHCI DMA engine 206 corresponds to cell position F₄M₄ (where N=4), which indicates to pre-wake logic module 208 that no EHCI DMA activity is scheduled at least until a microframe corresponding to cell F₁M₀, or 3.5 ms from the present. Thus, pre-wake logic module 208 may determine that no further actions, such as preparing a pre-wake indicator, need to be taken for approximately 3 ms or so.

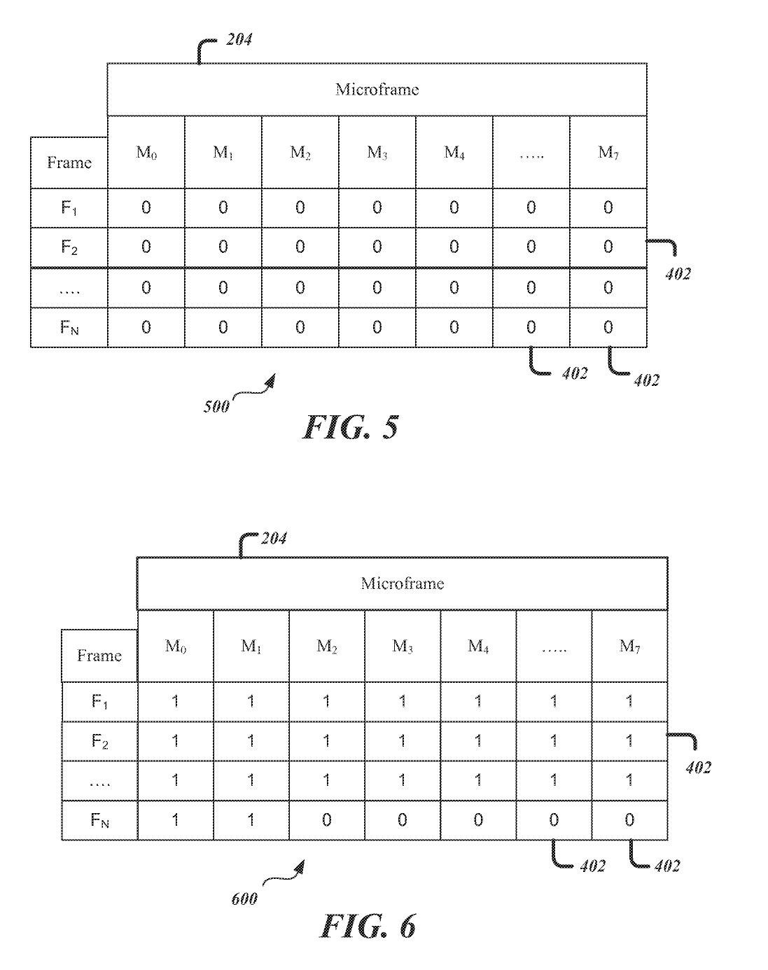

FIG. 6 depicts a third instance of scoreboard 204 having a third set of entries 600. In this instance, the scoreboard 204 cells have entries that all correspond to “1” indicators beginning at cell position F₄M₁. When the pre-wake logic module 208 examines scoreboard 204 at the instance depicted in FIG. 6, the pre-wake logic module 208 may determine based upon the frame counter index 210 that the current frame being processed by EHCI DMA engine 206 corresponds to cell position F₄M₄ (where N=4), which indicates to pre-wake logic module 208 that EHCI DMA activity is scheduled at a time corresponding to three microframes or 0.375 ms from the present. Thus, pre-wake logic module 208 may determine that a pre-wake indicator should be shortly forwarded to power management controller 108, so that the power management controller 108 can direct a timely exit of the processor 102 from a deep C-state in order that the processor 102 is restored to C-0 within about 0.375 ms.

In some embodiments, the scoreboard 204 may comprise a few rows (frames) as illustrated in the figures or may be many frames deep, that is, the scoreboard may include many rows that each corresponds to a USB frame of 1 ms duration. Each row may comprise eight cells corresponding to EHCI micro-frames each having a duration of 125 μs. In various embodiments the number of rows (F_{N}) in a scoreboard may vary over time, but may remain relatively constant for extended periods. The populating of scoreboard 204 may be performed intermittently by power management module 104, such as during periods in which processor 102 is in a deep C-state.

One advantage afforded by embodiments of the power management module 104 is that the processor 102 may be placed into a deep C-state during periods of USB inactivity while still being able to exit the deep C-state in a timely fashion when new activity resumes. Because the scoreboard 204 may provide the pre-wake logic module 208 with a “look ahead” of up to several milliseconds or more to determine EHCI DMA activity, the pre-wake logic module 208 may provide a pre-wake indicator in time to wake the processor 102 from a deep C-state as long as the programmed exit latency from the deep C-state does not exceed roughly the “look ahead” interval provided by scoreboard 204.

This contrasts with known techniques for managing USB traffic where an “EHCI DMA active” indicator may be asserted or de-asserted to a controller. A controller of a known system may place a processor in a lower power C-state when receiving a de-assertion of an “EHCI DMA active” indicator indicating that no USB transfers are to be processed. However, because of the need to maintain quality of service (QOS), the known system may require a minimal delay for handling EHCI transfers, which therefore may impose a maximum exit latency for the low power C-state of the processor. This required exit latency may be on the order of only a few μs to maintain proper QOS. For example, if the exit latency for a CPU in a deep C-state is on the order of one microframe duration (125 μs), for the CPU to begin a wake up process instantaneously without the pre-wake indicator of the present embodiments, an EHCI DMA engine processing a given micro-frame of USB traffic may be required to drop the processing of the micro-frame and may potentially cause user-visible errors in the data being processed. This consideration then prevents the processor from being placed into a deeper C-state whose exit latency may exceed the acceptable delay. Thus, during periods of USB inactivity the known systems may nevertheless be arranged to maintain a processor in a higher power C-state than necessary because of the inability to avoid impacting QOS for USB traffic for exits from a deep C-state.

In the present embodiments, as noted above, a power management module may adjust the timing of sending a the pre-wake indicator according to the present C-state of a CPU so that both QOS for USB traffic and processor power consumption are optimized. For example, pre-wake logic module may be arranged to receive a signal as to the current C-state of processor 102. Thus, if processor 102 is placed in a C6 state at a first instance, the timing of the pre-wake indicator issued by pre-wake logic module 208, or the timing of a wakeup signal from power management controller 108 to processor 102, may be arranged to take into account the exit latency from the C6 state. In one example of 125 μs exit latency, this may entail setting the exit of processor 102 from the C6 state to begin about 125-150 μs before scheduled EHCI DMA activity. Subsequently, if the processor 102 is placed in a C4 state having a lesser exit latency, the pre-wake indicator timing may be adjusted to compensate for the lesser exit latency. In one example, this may entail setting the exit of processor 102 from the C4 state to begin 50-75 μs before scheduled EHCI DMA activity. Accordingly, power management module 102 may occasionally or frequently adjust the relative timing between issuance of pre-wake signals and scheduled USB traffic in accordance with changes in a current C-state of a CPU in question.

In accordance with various embodiments, the size of a scoreboard during system operation may be maintained within a range. For example, pre-fetch engine 202 may perform prefetching primarily during a deep C-state period of processor 102 so that scoreboard 204 can be upon occasion repopulated with entries indicative of future EHCI DMA to replace entries corresponding to already performed EHCI DMA activity. In this manner, in a system that is largely idle, the processor 102 may be maintained in a deep C-state and the scoreboard 204 may be somewhat regularly updated to maintain its size. However, opportunistic prefetching may also take place when a processor 102 is in a C2 state when, for example, the scoreboard 204 is not full. Accordingly, the size of the size of scoreboard 204 may fluctuate over time.

In accordance with additional embodiments, the size of a scoreboard such as scoreboard 204 may scale in future processing systems according to advances in processor technology in order to satisfy varying future CPU latency requirements. Thus, a scoreboard depth equivalent to 1-2 USB frames may be sufficient to address CPU latencies typical of current technologies, where exit latencies from a C6 state may be on the order of 100 μs or so. However, exit latencies for deep C-states for future processor technologies are predicted to rapidly scale up into the ms time range. The present embodiments may therefore provide power management modules with scoreboards having depths of 4 ms or greater, in order to establish a “look ahead” of scheduled activity in excess of the exit latency.

Included herein is a set of flow charts representative of exemplary methodologies for performing novel aspects of the disclosed system and architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

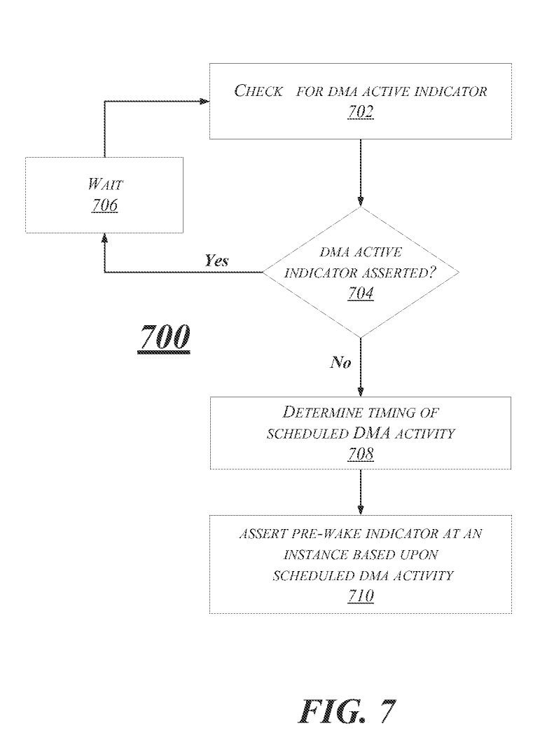

FIG. 7 depicts one exemplary logic flow 700. At block 702, a system is checked for a DMA active indicator. The DMA active indicator may indicate that a system is processing EHCI DMA traffic. At block 704 if the DMA active indicator has been asserted, the flow moves to block 706 where the system waits before returning to block 702. If, at block 704 the DMA active signal has not been asserted or has been de-asserted, the flow moves to block 708. At block 708, the timing of scheduled DMA activity is determined. The timing of scheduled DMA activity may correspond to the scheduled EHCI DMA activity to be performed. At block 710, a pre-wake indicator is asserted based upon the timing of scheduled DMA activity. In this manner, a processor that is presently in a deep C-state due to the current inactivity of EHCI DMA traffic may exit from the deep C-state at the time of the scheduled DMA activity.

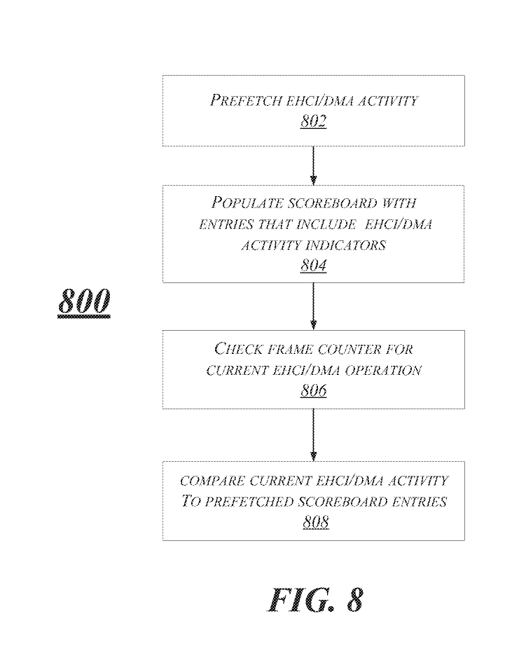

FIG. 8 depicts another exemplary logic flow 800. The logic flow 800 may represent blocks that are performed to determine timing of scheduled DMA activity and may comprise sub-blocks within block 708. At block 802, EHCI DMA activity is prefetched. In some embodiments, the prefetching may be performed while a processor is in a deep C-state period of a CPU. At block 804 a scoreboard is populated with entries that include EHCI DMA activity indicators that are based upon the prefetched EHCI DMA activity. The indicators may indicate whether a pre-fetched USB microframe corresponds to an active or inactive USB microframe. At block 806 a frame counter is checked to determine the current EHCI DMA operation. The frame counter may count microframes of an EHCI DMA engine to determine the current microframe. At block 808, the current EHCI DMA operation is compared to prefetched scoreboard entries. This may allow the relative timing between a current microframe of an EHCI DMA engine and a prefetched scoreboard entry indicating scheduled EHCI DMA activity.

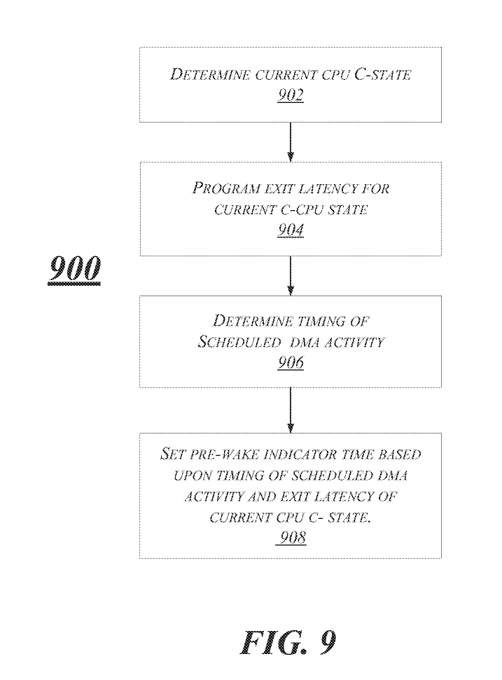

FIG. 9 depicts another exemplary logic flow 900. At block 902, a current CPU C-state is determined. At block 904 an exit latency is programmed based upon the current CPU state. A deeper C-state may require a larger exit latency, for example, than a shallower C-state. At block 906 a timing of scheduled DMA activity is determined. In some embodiments the determination may be performed according to blocks 802-808. At block 908 a time for asserting a pre-wake indicator is set based upon the timing of the scheduled DMA activity and the exit programmed exit latency of the current CPU C-state.

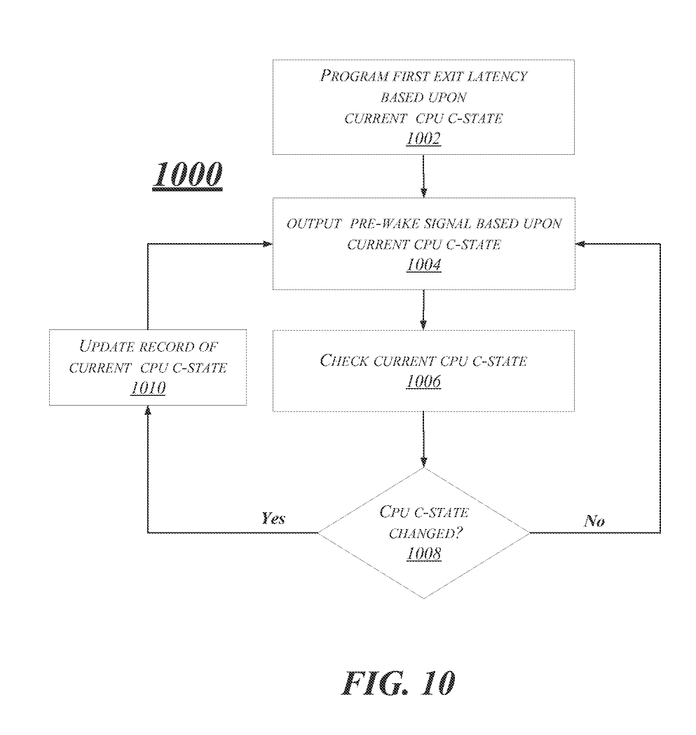

FIG. 10 depicts another exemplary logic flow 1000. At block 1002, an exit latency for a first CPU C-state is programmed. At block 1004 a pre-alert signal is asserted based upon a current CPU C-state. The pre-wake signal may be asserted with a timing determined as set forth in the logic flows 800-900. At block 1006 a current CPU C-state is checked. If, at block 1008, the current CPU C-state has changed from a previous CPU C-state used to assert the pre-wake signal at block 1004, the flow moves to block 1010 where a record of the current CPU C-state is updated. The logic flow then returns to block 1004, where the pre-wake signal is output based upon the current, updated C-state. If, at block 1008 the CPU C-state has not changed, the logic flow moves directly to block 1004.

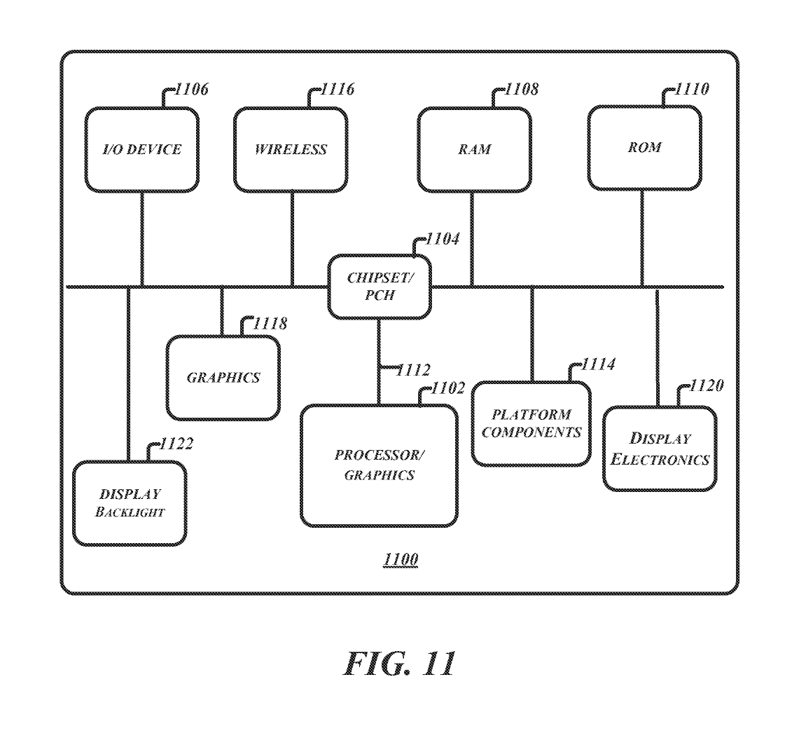

FIG. 11 is a diagram of an exemplary system embodiment and in particular, FIG. 11 is a diagram showing a platform 1100, which may include various elements. For instance, FIG. 11 shows that platform (system) 1110 may include a processor/graphics core 1102, a chipset/platform control hub (PCH) 1104, an input/output (I/O) device 1106, a random access memory (RAM) (such as dynamic RAM (DRAM)) 1108, and a read only memory (ROM) 1110, display electronics 1120, display backlight 1122, and various other platform components 1114 (e.g., a fan, a crossflow blower, a heat sink, DTM system, cooling system, housing, vents, and so forth). System 1100 may also include wireless communications chip 616 and graphics device 1118. The embodiments, however, are not limited to these elements.

As shown in FIG. 11, I/O device 1106, RAM 1108, and ROM 1110 are coupled to processor 1102 by way of chipset 1104. Chipset 1104 may be coupled to processor 1102 by a bus 1112. Accordingly, bus 1112 may include multiple lines.

Processor 1102 may be a central processing unit comprising one or more processor cores and may include any number of processors having any number of processor cores. The processor 1102 may include any type of processing unit, such as, for example, CPU, multi-processing unit, a reduced instruction set computer (RISC), a processor that have a pipeline, a complex instruction set computer (CISC), digital signal processor (DSP), and so forth. In some embodiments, processor 1102 may be multiple separate processors located on separate integrated circuit chips. In some embodiments processor 1102 may be a processor having integrated graphics, while in other embodiments processor 1102 may be a graphics core or cores.

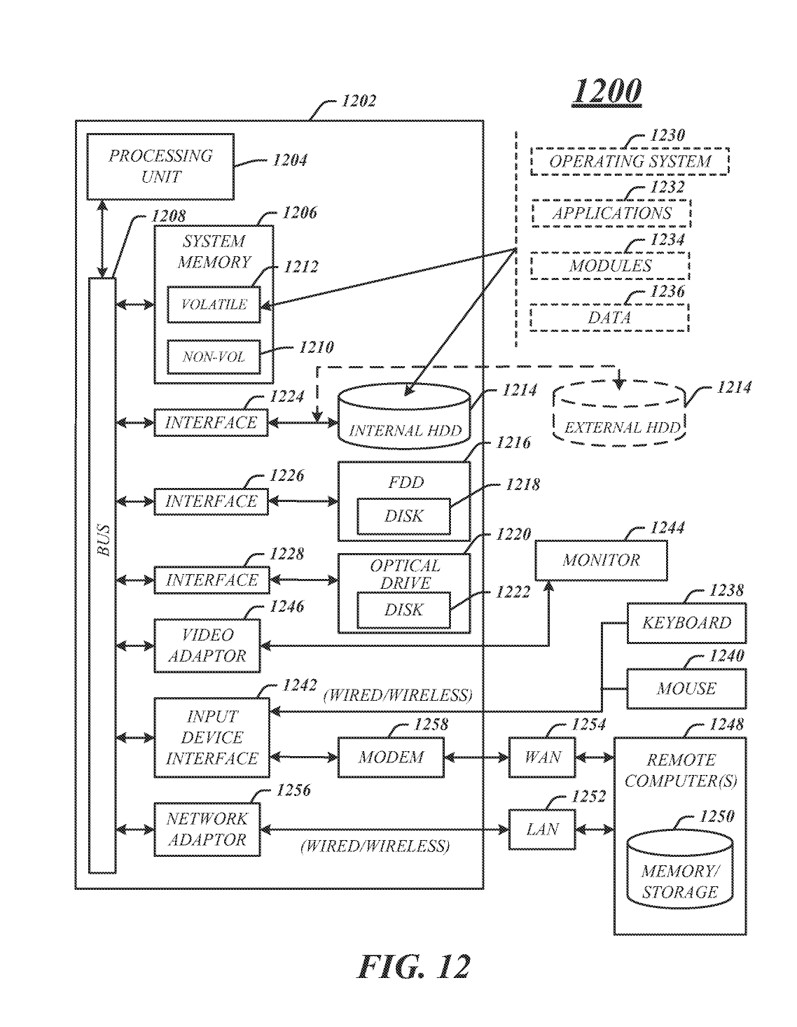

FIG. 12 illustrates an embodiment of an exemplary computing system (architecture) 1200 suitable for implementing various embodiments as previously described. As used in this application, the terms “system” and “device” and “component” are intended to refer to a computer-related entity, either hardware, a combination of hardware and software, software, or software in execution, examples of which are provided by the exemplary computing architecture 1200. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 1200 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 1200 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1200.

As shown in FIG. 12, the computing architecture 1200 comprises a processing unit 1204, a system memory 1206 and a system bus 1208. The processing unit 1204 can be any of various commercially available processors. Dual microprocessors and other multi processor architectures may also be employed as the processing unit 1204. The system bus 1208 provides an interface for system components including, but not limited to, the system memory 1206 to the processing unit 1204. The system bus 1208 can be any of several types of bus structure that may further interconnect to a memory bus (with or without a memory controller), a peripheral bus, and a local bus using any of a variety of commercially available bus architectures.

The computing architecture 1200 may comprise or implement various articles of manufacture. An article of manufacture may comprise a computer-readable storage medium to store various forms of programming logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of programming logic may include executable computer program instructions implemented using any suitable type of code, such as source code, compiled code, interpreted code, executable code, static code, dynamic code, object-oriented code, visual code, and the like.

The system memory 1206 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 12, the system memory 1206 can include non-volatile memory 1210 and/or volatile memory 1212. A basic input/output system (BIOS) can be stored in the non-volatile memory 1210.

The computer 1202 may include various types of computer-readable storage media in the form of one or more lower speed memory units, including an internal hard disk drive (HDD) 1214, a magnetic floppy disk drive (FDD) 1216 to read from or write to a removable magnetic disk 1218, and an optical disk drive 1220 to read from or write to a removable optical disk 1222 (e.g., a CD-ROM or DVD). The HDD 1214, FDD 1216 and optical disk drive 1220 can be connected to the system bus 1208 by a HDD interface 1224, an FDD interface 1226 and an optical drive interface 1228, respectively. The HDD interface 1224 for external drive implementations can include at least one or both of Universal Serial Bus (USB) and IEEE 1294 interface technologies.

The drives and associated computer-readable media provide volatile and/or nonvolatile storage of data, data structures, computer-executable instructions, and so forth. For example, a number of program modules can be stored in the drives and memory units 1210, 1212, including an operating system 1230, one or more application programs 1232, other program modules 1234, and program data 1236.

A user can enter commands and information into the computer 1202 through one or more wire/wireless input devices, for example, a keyboard 1238 and a pointing device, such as a mouse 1240. Other input devices may include a microphone, an infra-red (IR) remote control, a joystick, a game pad, a stylus pen, touch screen, or the like. These and other input devices are often connected to the processing unit 1204 through an input device interface 1242 that is coupled to the system bus 1208, but can be connected by other interfaces such as a parallel port, IEEE 1294 serial port, a game port, a USB port, an IR interface, and so forth.

A monitor 1244 or other type of display device is also connected to the system bus 1208 via an interface, such as a video adaptor 1246. In addition to the monitor 1244, a computer typically includes other peripheral output devices, such as speakers, printers, and so forth.

The computer 1202 may operate in a networked environment using logical connections via wire and/or wireless communications to one or more remote computers, such as a remote computer 1248. The remote computer 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wire and/or wireless device, connects to the system bus 1208 via the input device interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor;
first logic operable on the processor to output a direct memory access (DMA) activity indicator to indicate a current state of activity of direct memory access data transfer operations;
second logic operable on the processor to determine scheduled DMA activity to be performed; and
third logic operable on the processor to output a pre-wake indicator to a controller before the scheduled DMA activity is to be performed.

2. The apparatus of claim 1, the first logic to:
assert a DMA active indicator when direct memory access operations are being performed; and
de-assert the DMA active indicator when direct memory access operations are not being performed.

3. The apparatus of claim 1, comprising:
fourth logic to pre-fetch scheduled DMA activity to be processed by the first logic; and
a scoreboard having multiple scoreboard cells, one or more of the scoreboard cells including an indication of the activity to be processed for a universal serial bus (USB) microframe.

4. The apparatus of claim 1, one or more scoreboard cells comprising an activity indicator for a 125 μs interval of USB bus time.

5. The apparatus of claim 1, the fourth logic arranged to populate the scoreboard by polling a memory for USB traffic.

6. The apparatus of claim 1, the fourth logic to prefetch scheduled DMA activity when the processor is in a low power state that consumes less power than a second power state.

7. The apparatus of claim 1, the third logic arranged to:
determine a current frame processed by the first logic;
compare the current frame to an entry in the scoreboard; and
determine timing for asserting the pre-wake indicator based at least in part on the comparing the current frame.

8. The apparatus of claim 1, the scoreboard comprising an array of microframes, the third logic arranged to determine an offset between sending of the pre-wake indicator and a start of the DMA activity to be performed, based upon an exit latency of a current power state of the processor.

9. The apparatus of claim 1, the third logic arranged to output the pre-wake indicator only when the processor is in a low power state that consumes less power than a second power state.

10. A computer-implemented method, comprising:
determining at a first instance that no direct memory access (DMA) data transfer operations are taking place;
determining a second instance when scheduled DMA activity is to be performed by the system; and
outputting at third instance a pre-wake indicator to a controller when no DMA data transfer operation are taking place, the third instance being set before the second instance.

11. The computer-implemented method of claim 10, comprising:
asserting a DMA active indicator to the controller when direct memory access operations are being performed in the system; and
de-asserting the DMA active indicator to the controller when direct memory access operations are not being performed.

12. The computer-implemented method of claim 10, comprising:
pre-fetching scheduled DMA activity to be processed by a USB DMA engine;
polling a memory for universal serial bus (USB) traffic; and
populating each cell of a multiplicity of cells in a scoreboard with an indication of the activity to be performed for a respective USB microframe.

13. The computer-implemented method of claim 10, comprising populating each cell of a multiplicity of cells in a scoreboard with an indication of the activity to be performed for a respective USB microframe comprising a 125 μs interval.

14. The computer-implemented method of claim 10, comprising:
determining a current frame of an EHCI DMA engine arranged to process the data transfer operations;
comparing the current frame to an entry in the scoreboard; and
determining the third instance based at least in part on the comparing the current frame.

15. The computer-implemented method of claim 10, comprising:
determining an exit latency of a central processing unit (CPU); and
determining the third instance based upon an exit latency of a current power state of the CPU.

16. The computer-implemented method of claim 10, comprising:
programming a first exit latency for a CPU based upon a first CPU power state;
outputting a first pre-wake indicator at the third instance based upon the current CPU power state;
determining a second CPU power state different from the first CPU power-state;
programming a second exit latency for the CPU based upon the second CPU power state; and
outputting a second pre-wake indicator at a fourth instance based upon the second CPU power state.

17. An apparatus configured to perform the method of claim 10.

18. (canceled)
